(19) United States
(12) Patent Application Publication
(10) Pub. No.: US 2006/0259385 A1
(43) Pub. Date: Nov. 16, 2006

(54) Novel enhanced electronic hedge fund compliance tool

(75) Inventor: Irwin Menken, New York, NY (US)

Correspondence Address: GREENBERG TRAURIG LLP, 2450 COLORADO AVENUE, SUITE 400E, SANTA MONICA, CA, 90404, US

(73) Assignee: Communique, Compliance & Communications, LLP

(21) Appl. No.: 11/432,972

(22) Filed: May 12, 2006

Related U.S. Application Data
(60) Provisional application No. 60/680,922, filed on May 13, 2005.

(51) Int. Cl. G06Q 40/00

(52) U.S. Cl. 705/35

(57) ABSTRACT

A series of secured modules enables fund managers and their delegates to interact and support potential clients and customers with the user friendly support of the instant novel enhanced electronic hedge fund tool. Once enabled with appropriate security measure taken, the Internet links potential investors to Hedge funds at an interactive and uniquely crafted site providing a fund manager the ability to post all tools necessary to provide an unprecedented level of confidence to potential investors, from tailored presentations, user management and compliance information, including fully visible Securities and Exchange Commission data regarding the same from Compliance Forms/Securities and Exchange Commission Forms, regulatory policies and procedures, Compliance Reports, filing cabinets and reminders to electronically verifiable Compliance Approval mechanisms.

### RELATED APPLICATIONS

This application claims the benefit of and priority to U.S. Provisional Application Ser. No. 60/680,922, filed May 13, 2005, the contents of which are incorporated by reference herein in their entirety.

### BACKGROUND OF THE DISCLOSURE

A portion of the disclosure of this patent document contains material which may be subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

The present disclosure relates to tools to render financial instruments, such as Hedge Funds, more easily marketable and compliant with legal regulations, inter alia.

In particular, the present disclosure uses, for example, the Internet to render financial vehicles such as Hedge Funds SEC Compliant under ever evolving laws and government regulations, while making the vehicles themselves substantially more attractive to investors, both institutional and individual.

### SUMMARY OF THE DISCLOSURE

In the field of Internet communications, there are not commercially available or functionally utile combined systems enabling potential customers to view transmitted information, or have access to information regarding the nature of Hedge Funds in terms of SEC Compliance and the substance of the involved financial instruments concomitantly, let alone in a user-friendly way with the benefits of the instant disclosure.

Additionally, there are few electronic tools allowing the chief compliance officers of organizations or their functional homologues to fully manage and review compliance materials that must be generated and submitted within the organization.

The teachings of the present invention address these longstanding needs.

Briefly stated, with the user friendly support of the instant novel enhanced electronic hedge fund tool, the Internet links potential investors to Hedge funds at an interactive and uniquely crafted site providing a fund manager the ability to post all tools necessary to provide an unprecedented level of confidence to potential investors, from tailored presentations, user management and compliance information, including fully visible SEC data regarding the same from Compliance Forms/SEC Forms, regulatory policies and procedures, Compliance Reports, filing cabinets and reminders to electronically verifiable Compliance Approval mechanisms.

Also explained in the present disclosure is a novel business method for demonstrating the benefits of a financial instrument such as a hedge fund, comprising the steps of providing access to a series of modules that feature salient data points with respect to the involved financial instrument selected from the group consisting of commentary, news, weekly estimates, monthly actuals, personal portfolios, presentation/content format, user management information and compliance data, interfacing with at least a primary and a secondary user set, whereby data arrayed by a primary user is made selectively available to predetermined or programmed third parties or secondary user set members, creating a desired set of outputs using relational database elements and the data arrayed by the primary users, recording, tracking and storing said outputs, updating predetermined aspects of the involved data points, and repeating the above steps as needed to manage current and historical data sets and be able to present desired outputs with temporal proximity to the requests placed.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram demonstrating an embodiment of the relationship between a back-end 101 and a front-end, and the respective users thereof, according to the teachings of the present disclosure;

FIG. 2 is a flowchart of an embodiment of the present disclosure displaying options available to supervisors, according to the teachings of the present disclosure;

FIG. 3 is a flowchart of an embodiment of the present disclosure displaying options available to general users, according to the teachings of the present disclosure.

### DETAILED DESCRIPTION OF THE PRESENT DISCLOSURES

The inventor of the present disclosure has discovered a tool for providing real-time data to individuals who need the most up-to-date information regarding financial instruments and services in order to make optimal decisions. While the tool may provide data, such as the current status of SEC compliance documents and activities, the tool does not certify that the financial instruments or services are compliant, only the status as claimed by the responsible parties managing the instrument or service.

As used in this application, the term “link” means a button, hyperlink, or other method known in the art of submission of information to the software that causes the software to accept inputted data, signify choices, or navigate through different screens.

The present inventor offers for consideration a way to combine marketing and compliance in a single set of modules accessible electronically to any manner of users. A novel router device routes data according to a the functions and features disclosed herein.

By using known microelectronics and an innovative system architecture, what has been accomplished is a novel enhanced electronic hedge fund tool which comprises, in combination, a path to communicate between an interfacing mechanism and the Internet, a plurality of menu-based selections providing data with respect to a financial instrument or service, a multiplicity of pre-mapped links forming an architecture effective for guiding a user to a series of destinations, compliance module linking a user to SEC Compliance policies, forms, reports and procedures, and a record keeping and storage module enabling all essential data to be at least one of tracked, arrayed, stored, archived and accessed with security features enabling user access to be regulated.

Likewise, the novel enhanced electronic hedge fund tool of the present disclosure features secured access to select posted management and compliance information, and provides for a distinct advantage.

Similarly, the novel enhanced electronic hedge fund compliance tool, wherein said compliance module further comprises information necessary for a user to understand current Securities and Exchange Commission rules, regulations and compliance standards, and to create a resulting set of visual images that are postable, verifying the nexus between a particular hedge fund and said SEC Compliance policies, forms, reports, and procedures, adds substantial value to this deal.

Those skilled in the art will understand how, for example, communicating between a remote party and a central database processing resource through a computer network is also done, in embodiments of the instant disclosure, by subscription, and those skilled in the art understand that this further includes for example, the known steps of providing credit card information of a remote user prior to providing the data, and data being transferred to the remote user after charging a credit card for such data. Monies, for example as conventionally known, can be. transferred electronically via a telecommunications line between respective financial entities related to the remote party and to an operator of the central database. Since such transactional practices are known to artisans, further discussion of them is not included, rather incorporated expressly by reference herein, see, for example U.S. Letters Pat. No. 6,240,415 which is expressly incorporated herein as if fully set forth in this specification.

The present disclosure teaches router 102 wherein all information added by users, be they SEC compliance or other forms, investor information, and other data is routed to a chief compliance officer for approval by router 102 that collects compliance information into one electronic location accessible only by the chief compliance officer and those delegated to act in the behalf of the chief compliance officer. Once approved or rejected, users are notified of the status change. According to embodiments, notification of approval or rejection is accomplished via email. If approved, the item is made “live” and the user is notified with an status update on the item in their filing cabinet. If rejected, a rejection notes screen allows the supervisor to indicate reasons for the rejection and the user is granted an opportunity to correct the defects that caused the manager to reject the item. Email notifications comprise, in part, the text of the supervisors reasons for rejection, which puts the user on notice regarding defects that must be corrected in real-time.

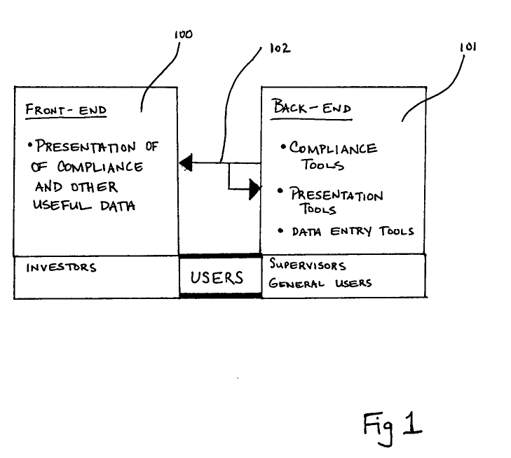

Moreover, according to embodiments, items that are made “live” are published to front-end 100 of FIG. 1 in real-time. Upon making an item “live,” the item is simultaneously approved and published as being approved in the relevant front-end 100 screens. Approval and publication are elements of router 102 taught by the present disclosure. This effectively gives investors and other interested parties a real-time tool to evaluate the performance, SEC compliance, and other relevant data regarding hedge funds.

According to an embodiment shown in FIG. 1, there is demonstrated an electronic hedge fund compliance tool. According to an embodiment demonstrated in FIG. 1, the electronic hedge fund management tool comprises a comprehensive tool with front-end 100 and back-end 101. Front-end 100 is an optional tool that allows investors and employees to review current hedge fund data and decisions in real-time. It will be apparent to artisans that front-end 100 is an optional tool that may be useful to certain classes of users and interested individuals and organizations. Nevertheless, back-end 101 may operate apart from front-end 101 as a useful tool in the management of hedge-finds.

Back-end 101, allows users to enter and access information related to at least one hedge fund, especially with respect to compliance with SEC requirements. All information entered by users into the electronic hedge fund compliance tool in back-end 101 are routed to the attention of an organization's chief compliance officer by router 102, who then acts on the matter. Depending on the decisions made regarding each individual item, the routing tools of the back end either direct the items to front-end 100 for real-time publication of data and decisions, or is routed by router 102 to various locations in back-end 101 for further action, correction, storage, or other useful functions that would be understood by a person of ordinary skill in the art.

Prior to a user having access to the electronic hedge fund compliance tool, each user must register to use the software. According to an embodiment, registration is connected with the collection of a fee or the subscription to the electronic hedge fund compliance tool service. Fees may be collected by traditional methods, such as the exchange of money or credit cards, or may be accomplished by an online mechanism. The method of collecting a payment for use of the electronic hedge fund compliance tool is well known to artisans.

In embodiments that comprise a subscription service, users will be granted access to the electronic hedge fund compliance tool on a periodic basis. Suitable periods may be weekly, monthly, quarterly, semi-annually, or annually. Other periods are equally suited for integration into the present disclosure. Generally, payment will extend the subscription through a period. After the period ends, the subscription will need to be renewed by additional payment. Subscription service models are well known in the art, especially as applied to software access.

After tendering payment, or subscribing, each user will be issued a user name and password. Each user name will be unique. Users may either be assigned a password or choose their own password. If the password is assigned, users may later have the option to change their password, in embodiments.

Back-end 101 users are either general users or supervisors. Supervisors have additional permissions, including the ability to review, approve, reject, and delete various compliance related documents. Moreover, supervisors may access records for all users, whereas general users are limited to access of only their own documents. General users cannot approve or reject their own documents and have limited access to certain software modules as detailed below.

In embodiments, other permission levels exist. For example, officers and managers who are SEC compliance officers may be able to review documentation for subordinates or on an organizational level with a management permission. Thus, while not technically compliance officers, they are able to monitor the activity within a hedge fund on a more general level. Nevertheless, with management permission, officers and managers have the ability to evaluate all information managed by the electronic hedge fund compliance tool without the ability to modify the information. Management permission would generally differ from a general users permission because managers may access software modules unavailable to general users.

In embodiments, investors in the hedge fund may be assigned a permission level that allows them to review compliance related documents. This permission level would prevent investors from adding, modifying, or deleting documents. Indeed, in embodiments confidential information may be withheld from investors read access permission, allowing the supervisors, general users, and management users to post confidential information without worry that the information will be disseminated to parties not privy to the information. In embodiments, investor access is accomplished through the use of the software's optional front-end 101.

Users may be required to agree to one or more licensing agreements or other statements of rules. These screens would be presented to the user at the first login or at other times, when appropriate. Other messages may be displayed to users as well, when necessary to inform users of changes or other information pertinent to their experience with the present disclosure.

According to an embodiment, users may not access the electronic hedge fund compliance tool without first logging in. In the embodiment, users direct their web browsers to a domain comprising the electronic hedge fund compliance tool software. Upon selecting to use the tool, either as a default when accessing the domain, or from another screen within the domain, each user must login with their username and password. Once logged in, users may then access the other features of the electronic hedge fund compliance tool, commensurate with their permission level. Front-end 100 and back-end 100 may be accessed through the same domain name and path, a different path on the same domain, or on a different domain altogether.

In an alternate embodiment, users may have limited access to information without logging in. In such embodiments, investors would be able to access various information without needing to login or to be issued a username and password. Login is required for other site functions and access. The limited access may be accomplished using the optional front-end, which would provide only limited information such as descriptions of the hedge funds, until the investor logs in.

FIG. 1 shows an illustrative, but not limiting example in the form of a block diagram of the relationship between front-end 100 and back-end 101, including their respective users. According to an embodiment, front-end 100 serves as a read-only review mechanism. It comprises information that may be accessible to investors and other persons of interest, such as employees. It comprises links to information sources. According to an embodiment, the information sources comprise a “Weekly Estimates,” “Commentary/Archives,” “Personal Portfolio Monthly Actuals,” “Performance Since Inception,” “Team,” “Fund Overview/Strategy,” “News,” and a “Links” links. Briefly, the “Performance Since Inception” link causes the software to display a screen that either provides data or links to data on the performance of the hedge funds managed by the software.

This link may also provide data on nonrelated funds. The “Team” link causes the software to display a screen where biographical information may be obtained on the management team or organization. Likewise, “Fund Overview/Strategy” causes the software to display a screen detailing general information regarding each fund, including for example, strategies, investment policies, and general overviews. The “Links” link provides links to 3^{rd} party services or products that may be of interest to investors or other visitors to front-end 100. The remaining links are discussed below in the context of their corresponding back-end 101 modules. Implementation of front-end 100 would be understood and well-known to a person of ordinary skill in the art.

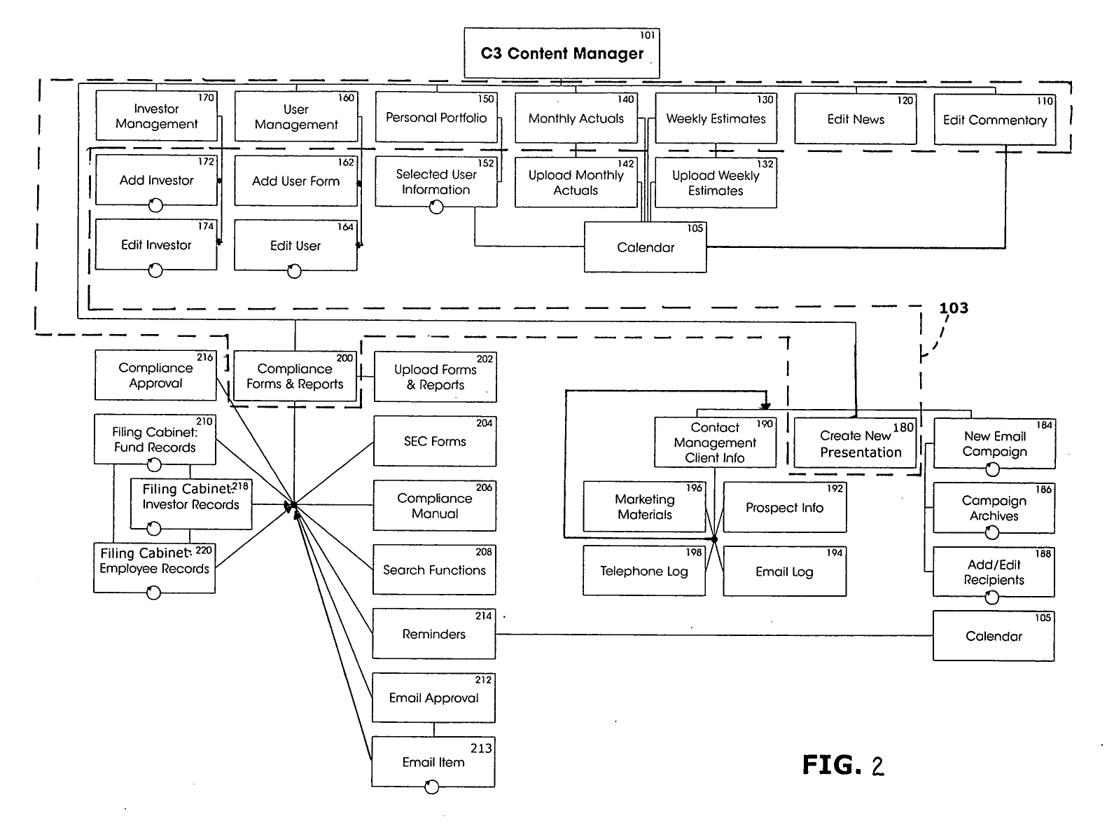

Turning now to back-end 101, modules forming core back-end 101 are exemplified by the flowchart in FIG. 2. Once logged into back-end 101, the software takes the user to a main back-end 101 screen or “C3 Content Manager” screen 101. From this screen, users select software modules to access from main menu 103. Thus, this screen serves as a launch point for the rest of the software modules once a user is logged in. From “C3 Content Manager” screen 101, users select options from main menu 103.

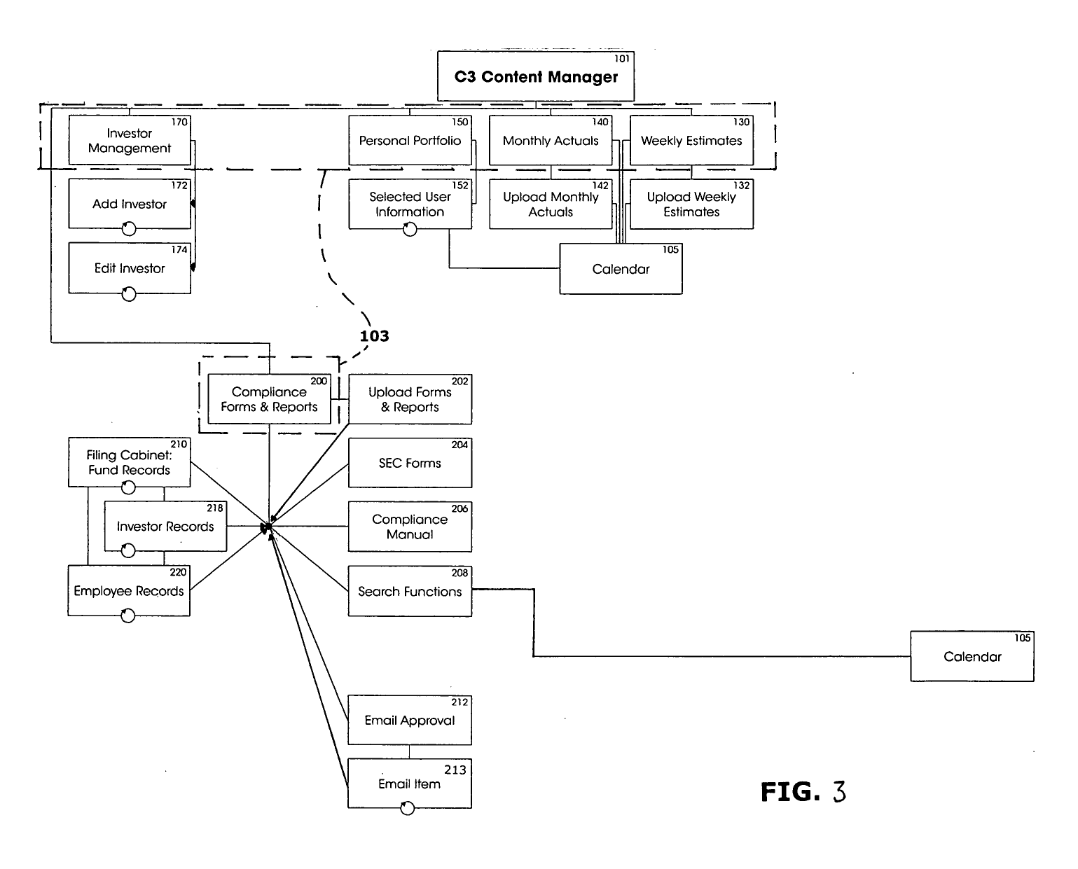

According to an embodiment, main menu 103 appears on each screen displayed. For general users, menu items include “Weekly Estimates,” “Monthly Actuals,” “Personal Portfolio,” “Investor Management,” and “Compliance” options to select from. The menu for supervisors comprises the above menu items, as well as “Commentary,” “News,” and “User Management.” Users may select any one of the options shown on main menu 103 at any point in their viewing experience to navigate to a screen showing different information or options. FIG. 2 demonstrates the interrelationship of back-end 101 accessible by supervisors. FIG. 3 demonstrates the corresponding back-end 101 accessible by general users.

Referring now to the individual modules of the embodiment represented in FIG. 2, supervisors may select the “Commentary” module link, which causes the software to display Edit Commentary screen 110 to be displayed. Edit Commentary screen 110 is split into two parts. One part comprises a form. Using the form, users may input commentary items. The form comprises three fields. The first field is the “Publishing Date” field. Users may either manually enter the date or click a calendar icon adjacent to the “Publishing Date” field. Clicking the calendar icon in “Commentary” or any other screen displaying the calendar icon causes the software to pop-up Calendar screen 105.

Calendar screen 105 is a pop-up screen that allows a user to select a date and have it entered into a date field correctly formatted. The window displays a single month, as the dates would be displayed on a monthly calendar. Nevertheless, in embodiments many variations of the display of dates is possible; the present disclosure expressly contemplates formatting the calendar window with single days, weeks, months, quarters, years, and combinations thereof. Each day in Calendar screen 105 links back to the originating screen, that is, the screen in which the user clicked the calendar icon and in so doing, populates the given date field with a correctly formatted date that the user selected.

In addition to the date links, Calendar screen 105 further comprises links that allow the user to change the month or the year displayed. Users may move forward or backward in time using the links for modification of the date or year. According to an embodiment, two month change modification links exist—one to advance the month ahead and one to regress the month backwards. Year modification links also exist, one that advances the calendar displayed ahead a year and one that regress it back a year. When any of the month modification or year modification links are pressed, a new monthly calendar is displayed representing the adjustment.

Turning back to Edit Commentary screen 110, in addition to the date field of the form, users complete two additional fields, “Commentary Title” and a large text field for entering text. In the “Commentary Title” field, users enter a title for the commentary that is entered into the large text field. Commentary items will be referenced by the title entered by the user in the “Commentary Title” field. Users may type text into the field or use copy and paste type functions to populate the field, as would be understood and practiced by a person of ordinary skill in the art. Text may be entered as plain text or in a suitable markup language, such as HTML or XML, in embodiments. Similarly, users may enter one or the other type text into the large text field that comprises the commentary associated with the date entered and the commentary title input. When the user completes the process of adding data to the form, the user clicks an “Add Commentary” link. Once pressed, the “Add Commentary” link causes the software to store the commentary item for later access.

The second part of Edit Commentary screen 110 comprises a list of commentary items that may be accessed. The commentary items are organized into a table. The table comprises the date the commentary item was published, the commentary title, the user who created the commentary item, the status of the item, and a list of action items. Commentary items are generally organized by their dates, which were entered into the date field at the time the commentary was entered. Each date is associated with the commentary name, creator, and the status. The status depends on the actions taken by supervisors with respect to each commentary items. Status identifiers include “Pending,” which indicates that action on the commentary item is yet to be taken, “Rejected,” which indicates that a supervisor rejected the commentary item, and “Live,” which indicates that a supervisor has approved the commentary item and made it “Live,” as previously described.

Action items are indicated by links to various actions including “View,” “Edit,” “Reject,” “Notes,” and “Make Live.” The links may be represented with words or icons. The “View” link displays a “Commentary Preview” screen that includes the date of the commentary, the commentary title, and the text of the commentary. This window may be presented as a pop-up window to streamline the process of navigating the software. In embodiments, users have the opportunity to click an email link in the “Commentary Preview” screen that will email a site editor.

When the “Edit” link is clicked, the form fields are populated with the commentary item data. Once the form fields are populated, the data within the fields may be edited and undated. Once a user is finished updating the commentary item, the user clicks a “Update Commentary” link. Should the user decide to forego edits to the commentary item, the user may click a “Cancel” link. Upon pressing the “Cancel” link, a cancel confirmation box may appear in embodiments requesting a confirmation of the “Cancel” request. This prevents inadvertent deletion of changes by merely clicking on the wrong link.

The “Reject” link allows a user to reject the commentary item and prevent it from becoming live. When the link is clicked, a “Reject Commentary” screen is displayed. The screen displays the title of the commentary, its date, and the person who created the commentary item. Additionally, a space is provided that allows the user rejecting the commentary item to detail reasons for the rejection or make other notes in a “Rejection Notes” section. Once comments are entered, if desired, the user clicks a “Reject Commentary” link to submit the rejection request, together with rejection comments, if entered. Alternately, if the user decides, after clicking the reject link in Edit Commentary screen 110, that they do not wish to reject the item, the user may click the “Cancel” link, the details of which are previously described.

Once rejected, the “Notes” action item may be accessed. Prior to rejection of an item, the “Notes” action item may not be accessed. Selecting the “Notes” action item displays a “Commentary Rejection Notes” screen. The screen comprises the title of the rejected commentary item, the date of its creation, the user who created the commentary item, the user who rejected the item, and the comments entered at the time of rejection. Once the user is done reviewing the “Commentary Rejection Notes” screen, the user may activate a “Close” link to close the screen. Once closed, the software will return the user to the Edit Commentary screen 110 or will close a pop-up window depending on the implementation of the “Commentary Rejection Notes” screen.

The “Make Live” link allows a user to approve the commentary item. Once approved, the commentary item becomes available for viewing. According to an embodiment, commentary may be viewed by users on front-end 100 under the “Commentary/Archives” link. Clicking on the link causes the software to display a view commentary screen. The view commentary screen displays the most recent commentary item. It also comprises a menu of archived commentary items. User may click on the link in each menu and have displayed by the software a screen containing archived commentary items.

In an alternate embodiment of the view commentary screen, all commentary items are accessed through the menu. The user then clicks the link of the commentary item that they wish to view, causing the software to display the corresponding commentary item in the same or new view commentary screen.

Edit News screen 120 of FIG. 2 allows users with access to edit news items in the “News” module. Edit News screen 120 comprises a large text area in which new items are entered. Users may type text into the field or use copy and paste type functions to populate the field, as would be understood and practiced by a person of ordinary skill in the art. Text may be entered as plain text or in a suitable markup language, such as HTML or XML, in embodiments. Once the user finishes entering text, the user clicks an “Update News” link, which causes the software to update news items.

According to an embodiment, commentary may be viewed by users in front-end 100 under the “News” link. Clicking on the news link causes the software to display a screen with the most recent news item.

Weekly Estimates screen 130 of back-end 101 allows user to input weekly estimates for each hedge fund tracked by the software. It is accessed by clicking on the “Weekly Estimates” module from main menu 103. Weekly Estimates screen 130 comprises a form section that is used to add new records, and an edit section that displays existing records for editing. Within the form section, each fund forms a separate sub-form, wherein data for that particular fund may be entered. If multiple funds are managed by the software, weekly estimate data may be entered for one or more funds. The software resolves which funds contain data entered by the user and creates new weekly estimate records only for those funds. In alternate embodiments, users would select specific funds from a list, for example, a drop-down list.

The sub-field for each fund comprises the following fields: “Date,” “Estimated NAV Beg. of week,” “Estimated NAV Change for week,” “Estimated NAV End of week,” “Percent Change for week,” “Estimated NAV Beg. of month,” “Estimated NAV Change for month,” “Estimated NAV End of month,” and “Percent Change for month.” The date is entered either manually or by using the Calendar screen 105 as described above. The user may input data for the other fields. In embodiments, the user input beginning of the week or month data and end of the week or month data and the software computes the Estimated weekly and monthly change field and percentage change fields. Once data is entered, the user clicks the submit link, which causes the software to create a new record and store the record.

Also displayed on Weekly Estimates screen 130 are a list of existing records entered previously by the user. Records are organized by fund, although other organization mechanisms, such as by date, are equally useful and may be implemented in alternate embodiments. Within each fund, records are displayed in order by date, together with the data that was entered for each weekly estimate record. Additionally, the record creator is listed along with the status of the record and action items. Status indicators are “Pending,” “Rejected,” and “Live.” These indicators are described previously in the present disclosure. Similarly, the action items are “Edit,” “Reject,” “Notes,” and “Make Live,” which are likewise described previously in the present disclosure, except that “Edit” action button shows a screen specifically designed for the entry of weekly estimate data. Weekly Estimates screen 130 further comprises a “Delete” action item.

Clicking the “Delete” action item allows users to delete the record associated with the link. In embodiments, the “Delete” link is coupled to a confirmation screen, which prevents accidental deletion of records by clicking the incorrect link.

Weekly Estimates also comprises an “Upload” link that causes the software to display Upload Weekly Estimates screen 132. Upload Weekly Estimates screen 132 is a form that allows users to upload weekly estimate fund data rather than manually entering the data. It comprises an “Upload Document” field. Users may either input the path and electronic document name or they may click on the browse link. The browse link causes the software to display a screen that allows the user to browse a disk drive for the file to upload. Such technology is well known to artisans.

Once the document name and path are entered into the “Upload Document” filed, the user selects the fund to which it applies. In embodiments, if only a single fund is administered by the website, the field may be absent. In embodiments, users may insert the fund name manually. Other embodiments allow users to select the applicable fund from a menu. After selecting the fund, the user enters the date, either manually or through the use of Calendar screen 105, as previously described. Once all the information is input into the fields, the user clicks an “Upload” link and the software causes the document to be uploaded from the user's local system to the server administering the electronic hedge fund compliance tool.

In embodiments, upload screens 132, 142, 202 display a list of uploaded documents. Documents are grouped by hedge fund, and listed in alphabetical order by name. Each document lists the date the document was created, the user who uploaded the document, and date of the upload. In embodiments, documents are. uploaded in conjunction with manual entry of the data as supplemental review information for the chief compliance officer and management to review. In these embodiments, supervisors do not approve the uploaded documents to reject or make live. Rather approval is required for the manually entered numbers. In alternate embodiments, uploaded documents are pending until approved in the same way that manual entries are approved. In both cases, embodiments may contain action items as previously described as well.

Upload screens 132, 142, and 202 also comprise a “Form” link that causes the software to display the screen to the corresponding manual entry screens 130, 140, and 200.

According to an embodiment, weekly estimates may be viewed by users in front-end 100 under the “Weekly Estimates” link. Front-end users are able to view the last set of weekly estimates that were input in back-end 101 on Weekly Estimates screen 130 or Upload Weekly Estimates screen 132. In embodiments, front-end users may also access previous weekly performance estimates by clicking on previous weeks that are listed in a menu. Clicking a week's estimates in the menu causes the software to display the corresponding week's estimates in the same or a different screen. Alternately in other embodiments, front-end users may access the same data by clicking the “Performance Since Inception” link in front-end 100.

Turning to the “back-end 101, the “Monthly Actuals” module is accessed with the “Monthly Actuals” link, which causes the software to display Monthly Actuals screen 140. Monthly Actuals screen 140 operates similar to Weekly Estimates screen 130, except for modified data fields. However, Monthly Actuals screen 140 requires input of only “Date,” “Estimated NAV beginning of month,” “Estimated NAV Change for month,” “Estimated NAV End of month,” and “Percent Change” for each hedge fund. Like Weekly Estimates screen 130, Monthly Actuals screen 140 comprises an upload feature, Upload Monthly Actuals screen 142, which is functionally identical to Upload Weekly Estimates screen 132, with the exception that uploaded documents are routed to the chief compliance officer by router 102, as described herein. Moreover, the data fields are all monthly, rather than weekly, and reflect real numbers as opposed to estimates.

The data shown for each uploaded document is the “Document's Name,” “Creator,” “Date Uploaded,” “Status,” and “Action.” Status identifiers are “Pending,” “Live,” or “Rejected.” Users have the opportunity to delete uploaded files by clicking on a delete link in the actions section. While Upload Monthly Actuals screen 142 differs from Upload Weekly Estimates screen 132 according to an embodiment, the present disclosure expressly contemplates that either upload screen may be functionally equivalent of the other.

According to an embodiment, monthly actuals numbers may be viewed by users on front-end 100 under the “Personal Portfolio Monthly Actuals” link. Front-end users are able to view the last set of monthly actuals that were input in back-end 101 on Monthly Actuals screen 140 or Upload Monthly Actuals screen 142. In embodiments, front-end users may also access previous monthly performance data by clicking on previous months that are listed in a menu. Clicking a month's estimates in the menu causes the software to display the corresponding month's data in the same or a different screen. Alternately in other embodiments, front-end users may access the same data by clicking the “Performance Since Inception” link in front-end 100.

Personal Portfolio screen 150 in back-end 101 displays a menu of users that may be selected. The “Personal Portfolio” module is accessed by selecting the “Personal Portfolio” link from main menu 103. The menu of users may be any type of electronic menu that is common in art that allows a user to make a selection which causes the software to display a different screen. According to the teachings of the present disclosure, once the user operating the software selects a user from the menu, the software causes the display of Selected User Information screen 152. If an embodiment were to comprise only a single user, clicking on the “Personal Portfolio” link on main menu 103 would cause Selected User Information 152 screen to appear in embodiments. Other embodiments would require the user operating the electronic hedge fund compliance tool to select a user from the menu that comprises Personal Portfolio screen 150.

In front-end 100, a user's personal portfolio may be viewed on the screen accessed with the “Personal Portfolio Monthly Actuals” link. The personal portfolio data displayed on the screen accessed with the “Personal Portfolio Monthly Actuals” link mirrors data entered in Selected User Information 152 in back-end 101. Because users may have invested in or have interest in one or more funds, but not all of the funds, data displayed in the “Personal Portfolio Monthly Actuals” screen may display information individually tailored for each individual user. In embodiments, the portfolio data may include other, non-hedge fund data such as stock or options belonging to a user's portfolio.

User Management screen 160 and Investor Management screen 170 are portals to management tool in back-end 101. Each screen comprises an “Add” link and a “Edit/Delete” link. Once the user clicks on one of the links in the portal screen, the user does not return to the portal screen unless the “User Management” link or “Investor Management” link is selected from main menu 103. General users have access to “Investor Management” module link; only supervisors may access the “User Management” module link.

Add User screen 162 allows supervisors to add users and assign passwords. In conjunction with each addition of a user, the supervisor completes a form. According to an embodiment, Add User screen 162 comprises 4 fields: “New User ID,” “Password,” “User Name,” and “User Email Address.” After a supervisor fills in each field in the Add User screen 162, an “Add User” link is clicked, which causes the software to add a user record with the data entered into the form. The form also comprises a supervisor permissions switch that allows the supervisor entering the user information to grant each new user supervisor permissions. The supervisor permissions switch may be a menu, radio button, check box, or equivalent type of implementation that allows a supervisor to designate the new user's permission level, and is well understood by a person of ordinary skill in the art.

Similarly, Add Investor screen 172 allows users to add investors. Like users, investors receive a username and password. Add Investor screen 172 comprises three fields: “New Investor ID,” “Password,” and “Investor Name.” Users also select the hedge funds that investors may access using hedge fund switches for each fund managed by the electronic hedge fund compliance tool. The hedge fund switches, comprising one or more hedge funds, may be a menu, radio buttons, or check boxes. Implementation of hedge fund switches is well understood by persons of ordinary skill in the art. Once the form is completed and the hedge funds selected, the user clicks an “Add User” link, which causes the software to add the user record.

Edit User screen 164 and Edit Investor screen 174 allow supervisors to modify user and investor information respectively. Both screens require the user operating the electronic hedge fund compliance tool to select a user or investor from a menu to edit. The menu may be implemented in many ways common in the art, including using hyperlinks, drop-down menus, or equivalent ways that would be implemented by a person of ordinary skill in the art. According to an embodiment, users or investors are selected from a drop-down menu. Once the user or investor is selected, the user operating the electronic hedge fund compliance tool clicks an “Edit” link, which causes the software to display the user or investor data. The user operating the electronic hedge fund compliance tool may also click a “Delete” link, after selecting a user from the menu, to delete the user or investor. In embodiments, user or investor data is displayed in a new screen or a pop-up screen. However, an embodiment displays the user or investor information on the same screen as the menu, allowing for editing of multiple users with a minimum amount of navigation.

Edit User screen 164 is identical to the Add User screen, with the exception that the User ID field may no longer be modified. All other fields may be changed, including the user's password, name, and email address. Supervisor access may be granted or revoked as well. When the modifications are complete, the supervisor clicks a “Save” link to update the user information.

Similarly, Edit Investor screen 174 is identical to Add Investor screen 172, with the exception that the Investor ID field may no longer be modified. All other fields may be changed, including the investor's name, and password and the funds to which the investor has access. When the modifications are complete, the user clicks a “Save” link to update the user information.

Moreover, according to an embodiment, two unique switches are presented to the supervisor in Edit Investor screen 174. These are “Active” and “Guest.” Switches are implemented as described previously and are well known in the art. By default according to an embodiment, both items are active. The “Active” switch allows investors to access the site. Deactivating this switch preserves the account information, but prevents the investor from accessing front-end 100. “Guest” switch allows for temporary access to front-end 100.

Supervisors may manage marketing by selecting the “Marketing Tools” module link on main menu 103. Selecting the “Marketing Tools” link causes the software to display Create New Presentation screen 180. Supervisors may create marketing pitches using the tools on this screen. The screen is divided into a create presentations form, allowing the creation of marketing presentations, and a list of previously created presentations.

The create presentation form initially comprises 4 fields: “Create Presentation Name,” “Password,” “Publishing Date,” “Header,” and a text input field. The Supervisor enters a presentation name and password. The “Publishing Date” field allows supervisors to manually enter a date or access Calendar screen 105. The process for entering dates was described previously herein. The “Header” field allows the supervisor to create a title for the presentation. Finally, the supervisor enters text into the text input field as previously described. The text forms the body of the presentation.

In embodiments, supervisors may also attach files to the presentation in an optional field. Attaching files occurs as previously described for uploading files. The supervisor may either input the file name and path manually or select the file using a “Browse” function.

The list of previously created presentations includes the presentation's name, the date input at its creation, the header information, and action items. Action items include a “Preview” function, “Edit,” and “Remove” action items. When the “Preview” item is activated, the software causes a presentation screen to be displayed showing the presentation. The “Edit” allows the supervisor to edit the presentation, as previously described. Finally, the “Remove” function allows users to remove the presentation.

In embodiments, removal of a presentation removes the presentation from “Active Presentations” to an “Archived Presentations” presentations list. The “Archived Presentations” list is displayed on either the same screen as the “Active Presentations” or on a different screen. The “Archived Presentations” list contains the same basic information as the items comprising the “Active Presentation” list, except that there are but two action items: “Preview” and “Restore.” The “Preview” action item works as though the item were on the “Active Presentations” list. “Restore” moves the presentation from the “Archived Presentation” list to the “Active Presentation” list.

In addition to the creation of presentations, supervisors may also conduct email marketing campaigns with the electronic hedge fund compliance tool's email marketing module. Once selected, the “Marketing Tools” link on main menu 103 expands to allow supervisors to select “Presentations,” “Email Marketing,” and “Contact Management.”

Selection of the “Email Marketing” link causes the software to display New Email Campaign Screen 184. New Email Campaign Screen 184 is divided into a form for composing an email campaign and a list of active campaigns. The form used to compose a new email campaign comprises a “Date” field, which may be completed as previously described, a “Subject” field, and a text input field. Files may be uploaded and attached as previously described.

Recipients are selected by selecting an “Add/Edit Members” link. When selected “Add/Edit Members” causes the software to display Add/Edit Recipients screen 188. On this screen, supervisors may either enter email recipient contact information. In alternate embodiments, the information may by coupled to the “Contact Management” link that forms part of the “Marketing Tools” link submenu.

Active email campaigns are listed in New Email Campaign screen 184. The list entry shows the creation date of the email, the subject line, the presence of an attachment with a link to view the attachment, a status indicator, and action items. Action items include “Edit,” “Remove,” and “Send,” the operation of each of which is detailed herein or understood by a person of ordinary skill in the art. Once sent, email campaigns are archived.

Campaign Archives screen 186 may be accessed from New Email Campaign screen 184 or Add/Edit Recipients 188. Indeed, each of these screens may be accessed by a link within the Email Marketing module. Campaign Archives screen 186 displays a list of previously sent email campaigns. The list is identical to the email campaign list in New Email Campaign screen 184, except that the only action item, “Reactivate,” reactivates the email campaign for editing and resending. Reactivated email campaigns appear in the email campaigns list on New Email Campaign screen 184.

Finally, the last element of the “Marketing Tools” link in main menu 103 is a contact management module. The contact management module allows supervisors to manage contacts. Within the module, links exist that cause the software to open various contact information screens including “Client Information,” “Prospect Information,” “Marketing Materials,” “Email Logs,” and “Telephone Logs.” These links cause the software to display Client Info screen 100, Prospect Info screen 192, Marketing Materials screen 196, Email Log screen 194, and Telephone Log screen 198 respectively. Implementation of the contact management module varies depending on the client. Nevertheless, implementation of such a module would be easily understood and accomplished by a person of ordinary skill in the art. The contact management module, however, may be integrated into all aspects of the electronic hedge fund compliance tool and, particularly for the email marketing module, be integrated and streamlined for management of contact and prospect information and record keeping.

The last main menu selection is the “Compliance” module link, which forms the heart of the electronic hedge fund compliance tool. Clicking the “Compliance” module link opens a submenu in main menu 103 of options: “Forms & Reports,” “SEC Forms,” “Compliance Manual,” “Search Functions,” “Filing Cabinets,” “E-mail Approval,” “Reminders,” and “Compliance Approval.” General users do not see the “Reminders” or “Compliance Approval” links, which are available only to supervisors. Clicking on the “Compliance” module link also causes the software to display Compliance Forms & Reports screen 200.

Compliance Forms & Reports screen 200 comprises a forms menu and an “Upload” forms link. According to an embodiment, the forms included in the forms menu are “Annual Compliance Acknowledgement,” “Quarterly Securities Transaction Summary,” “Annual Securities Holdings Summary,” “Conflicts of Interest,” “Pre-Clearance for Securities Transactions Form,” “Trade Error Report,” “Conflict Report,” “Best Execution,” “Marketing Materials Approval,” “Proxy Voting,” “Soft Dollar,” “Value Certification,” and “Investor Accreditation.” When a user selects a form from the menu, they can either print and complete the form, or complete the form electronically by filling in a software supplied form. If users complete a software supplied form, the data may then be integrated into the software for automated compliance reporting and maintenance. After clicking the link for each form, the software displays a screen alerting the user of the last time they completed the form or that the user will be completing it for the first time. Implementation of forms supplied by the software is well known to those skilled in the art.

Moreover, the selection and nature of the forms that may be completed by users would be understood and known to a person of ordinary skill in the art. Indeed, an organization's chief compliance officer may select various forms to be implemented or uploadable depending on the organization's needs, policies, and procedures. To that end, forms may be specifically designed or optimized depending on the needs of each organization. Users “sign” software supplied forms by clicking “Submit” links after completing each form. Data supplied in other modules of the electronic hedge fund compliance tool may be autofilled or provided as menu selections to users for applicable fields in the software supplied forms, where appropriate. Examples of such data include names of hedge funds, investors, users; contact information for investors and users; data supplied in completed and submitted forms; weekly estimate numbers and monthly actuals; and or applicable data items available to the software. Indeed, in embodiments, the electronic hedge fund tool may integrate with software from third party vendors, such as calendaring or contact management software.

Clicking the “Upload” forms link causes the software to display Upload Forms & Reports screen 202, which allows users to select from a menu a variety of forms that may be uploaded. The forms that may be uploaded using Upload Forms & Reports screen 202 may vary from the forms that may be completed or printed using Compliance Forms & Reports screen 200. Once the user selects a form that will be uploaded, the upload functions work are previously described herein.

Clicking the “SEC Forms” link in the “Compliance” link submenu causes the software to display SEC Forms screen 204. SEC Forms screen comprises an SEC Forms menu. Users may select a form, which is either a software supplied form, a form that can be displayed, printed, and manually completed, or a link to a website containing the selected form. According to an embodiment, user may select “View Advisor Form,” “Amend Advisor Form,” “SEC Form 3,” “SEC Form 4,” “SEC Form 5,” “SEC Form 13D,” “SEC Form 13F,” and “SEC Form 13G.” The forms according to an embodiment may be filled in online, printed and completed manually, or linked to a third party website containing the forms, such as the SEC website.

Clicking the “Compliance Manual” link in the “Compliance” link submenu causes the software to display Compliance Manual screen 206. The “Compliance Manual” details various policies, statements, requirements, and instructions for users of the hedge fund compliance tool. These details may pertain to use of the electronic hedge fund compliance tool or organizational policies, statements, or requirements. The implementation of the “Compliance Manual” may be as a web page, with various topics linked together or individual documents for download, or a combination thereof. Other suitable methods understood to persons of skill in the art are likewise contemplated.

Clicking the “Search Functions” link in the “Compliance” link submenu causes the software to display Search Functions screen 208. The search functions allow users to search data within the electronic hedge fund compliance tool. Search Functions screen 208 comprises a menu of searchable data sets. Implementation of the menu is described previously herein and understood by persons of ordinary skill in the art. In embodiments, the sets of data that may be searched are “Monthly Actuals” data, “Personal Portfolio” data, “Fund Records” data, “Client Records” data, and “Employee Records” data. Each of these data sets are searchable by date range. Users input manually or using Calendar screen 105 date that comprise a date range to search. Other embodiments use keyword searching, record number searching, or other applicable search criteria known and understood by persons of ordinary skill in the art.

Clicking the “Filing Cabinets” link in the “Compliance” link submenu causes the software to display Filing Cabinets: Fund Records screen 210. Listed in each filing cabinet screen is a submenu comprising “Fund Records,” “Investor Records,” and “Employee Records” links corresponding to Filing Cabinets: Fund Records screen 210, Filing Cabinets: Investor Records screen 218, and Filing Cabinets: Employee Records screen 220 respectively.

Filing Cabinets: Fund Records screen 210 comprises a fund menu containing the funds managed by the electronic hedge fund compliance tool. In embodiments that manage only a single fund, the menu may be omitted and fund data displayed. The fund menu may be implemented as previously described.

Once a fund is selected from the menu, Filing Cabinets: Fund Records screen 210 updates with the fund data, in addition to the previously displayed menu. Fund records are listed, together with an upload fund document form, are useful in supplementing fund data. The Upload form is implemented as previously described, except the user must select a document type from a menu of document types. Implementation of the menu is also as previously described. Types of documents depend on the needs of the organization, and many combinations of document types are possible. According to an embodiment, document types comprise the following: ADV Part IIs, Business Recovery Contact Chains, Distributions Agreements, Financial Statements, Investor Letters, Legal Organizational Documents, Marketing Presentations, Monthly Actuals, Offering Memoranda, Organizational Charts, Performance Data, Regulatory Inquiries, Subscription Agreements, and Weekly Estimates.

Fund records are listed in fund records filing cabinet. They are generally organized according to an organizing principle useful to the users who use the filing cabinet. Indeed, sortable organizing fields may be employed in embodiments to allow users to organize the data based on each user's individual preference. Additionally, email records may be stored in the filing cabinet of a particular fund. If documents are rejected, users may review rejection notes as part of a “Please Correct” action item with the documents in the filing cabinet.

Filing Cabinet: Investor Records screen 218 and Filing Cabinet: Employee Records screen 220 are identical to Filing Cabinet: Fund Records screen, except that the actual data posted will pertain broadly to investors or employee respectively, rather than particular hedge funds. Additionally, document types in the Upload section and displayed will vary by each respective screen. For example, according to an embodiment, document types that may be uploaded in Filing Cabinet: Investor Records screen 218 include ADV Part I us, Correspondence, Customer Complaints, Fund Financial Statements, Letters to Investor, Marketing Materials, Offering Documents, Privacy Policies, Side Letters, and Suitability Forms. Document types in Filing Cabinet: Employee Records screen 220 include Annual Compliance Acknowledgements, Conflict of Interest Forms, Employee Terms, Employment Agreements, Monthly Reportable Securities, Monthly Securities Holdings Summaries, Personal Information, Pre-Clearance for Securities Transactions, and Quarterly Securities Disclosures.

Clicking the “Email Approval” link in the “Compliance” link submenu causes the software to display Email Approval screen 208. Email Approval screen 208 comprises a list of email items received by the user. The user may select individual email item by clicking on a link to the email item, causing the software to display Email Item screen 213 comprising the contents of the email. After viewing the email, users may move the email to the “Filing Cabinets” module.

In embodiments, menus are presented to the user that allow the user to select the correct filing cabinet to store the email. According to an embodiment, users may select to file the email in the “FUND Filing Cabinet,” “INVESTOR Filing Cabinet,” or “USER Filing Cabinet.” Once the Filing Cabinet is selected, submenus allow the user to specifically direct the email. For example, if the user selects “FUND Filing Cabinet,” a submenu of funds become available. The user then selects a fund and clicks on a “Forward” link, which moves the email into the specified filing cabinet. Embodiments of the present disclosure contemplate moving the email to the filing cabinet or copying the email to the filing cabinet, which would allow the user to store copies of the email in all relevant filing cabinets rather than a single cabinet. Copies of the email may continue to be stored in a users email archive, even after forwarding to a filing cabinet.

Clicking the “Reminders” link in the “Compliance” link submenu causes the software to display Reminders screen 214. Reminders screen 214 comprises two sections: an “Add New Reminder” form and a list of “Existing Reminders.” Only supervisors may access the “Reminders” link.

The “Add New Reminder” form allows supervisors to create reminders for users. The implementation of forms is well understood by persons of skill in the art. According to an embodiment, the supervisor fills in a number of fields including: “Recurrence,” “Options,” “Reminder Date,” “Reminder Recipients,” and “Reminder Type.” The “Recurrence” field allows the supervisor to set up reminder that is automatically sent on a recurring basis. Supervisors may enter either a time period or select a time period from a menu. Implementation of such a menu was discussed previously herein. Options for recurring may be in any time frame unit. Typical choices might include once, daily, weekly, monthly, quarterly, semi-annually, and annually. The recurrence is based on the “Reminder Date,” which can be manually entered or selected using Calendar screen 105, as previously discussed. The reminder date can either constitute a due date to accomplish the task associated with the reminder or the date on which the reminder is sent. The “Options” field allows supervisors to specify a time period before the reminder's deadline in which the reminder is sent. “Options” may be manually specified in a number of minutes, hours, days, weeks, months, or years, or the supervisor may select a time period from a menu, the implementation of which was previously discussed. According to an embodiment, typical “Options” times may include the same date as the reminder, one day before the reminder date, a week before the reminder date, a month before the reminder date, or an arbitrary time period before the date that is useful for the recipient or useful for the sender.

“Reminder Recipients” may be general users, supervisors, investors, or combinations thereof. According to an embodiment, reminders would be used to remind employees of an organization of their duty to complete various tasks.

The type of task that must be completed is indicated by the supervisor in the “Reminder Type” field. The reminder field may allow supervisors to manually enter the type of reminder, the reminder may be chosen from a menu, or both. All tasks, both tasks related to the electronic hedge fund compliance tool and unrelated tasks, may be inputted into the “Reminder Type” field. Those tasks associated with the electronic hedge fund compliance tool may be integrated with the reminder to provide the user with a portal for accomplishing the desired task.

Supervisors may view a list of reminders in the “Existing Reminders” portion of Reminders page 214. Reminders may be organized by their various data, including due date, type of reminder, user, and other useful information. According to an embodiment, reminder fields displayed are “Type,” “Date,” “Options,” “Recurrence,” and “Recipients,” although other combinations are equally effective depending on the information desired by supervisors in managing the reminders. Additionally, action items may be included such as “Edit” and “Delete,” giving supervisors a mechanism to modify or remove existing reminders.

Clicking the “Compliance Approval” link in the “Compliance” link submenu causes the software to display Compliance Approval screen 216. All items submitted with the electronic hedge fund compliance tool are routed by router 102 to the “Compliance Approval” module. In this screen, supervisors review submitted, pending items and either approve (make live), reject, or delete them. Items may be grouped or organized by any suitable method based on the preferences of the supervisors. According to an embodiment, Compliance Approval screen 216 comprises three sections: “Fund,” “Investor,” and “Employee” as the general organizing principle. Within each section, items may be further organized or categorized for ease in the review process.

The Compliance Approval module forms the heart of the electronic hedge fund compliance tool. It provides a central location in which a chief compliance officer may monitor an organization's compliance to SEC rules and regulations, among other things. Indeed, everything from weekly and monthly numbers to SEC required forms to employee acknowledgement of their duties with respect to SEC compliance may be viewed on a single screen.

Within the Compliance Approval module, supervisors may, for each item, click on an action item. According to an embodiment, actions links comprise “Make Live,” “Reject,” and “Delete.” When an item is approved, the item is made live, wherein it is both approved and published to front-end 100, if present, in real-time. When an item is “Rejected,” the software causes a screen to display a screen for entering notes associated with the rejected item, as previously described herein. In other instances, the supervisor may simply delete the items to prevent them from being displayed on the front end of the software.

While the device and methods of the present disclosure have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A electronic tool comprising, in combination:
a router that routes Securities and Exchange Commission compliance data to an electronic location for approval for the purposes of ensuring compliance with Securities and Exchange Commission requirements and allowing for real time communication of compliance data to interested parties;
wherein upon approval of the Securities and Exchange Commission compliance data and communication of the compliance data to at least one interested party occurs in about close succession.

2. The electronic tool of claim 1, wherein the about close succession is about instantaneously.

3. The electronic tool of claim 1, wherein the electronic tool further comprises front-end and back-end;
wherein the front-end displays data related to compliance to the at least one interested party; and
wherein the back-end provides compliance modules and an approval module.

4. The electronic tool of claim 3, wherein the approval module comprises a process for at least approval and rejection of Securities and Exchange Commission compliance data; and
wherein rejected Securities and Exchange Commission data is routed by the router to an originator.

5. A router comprising, in combination:
at least a path to communicate between an interfacing mechanism and the Internet;
a compliance module linking a user to policies, forms, reports, and procedures; and
a record keeping and storage module enabling data to be at least one of tracked, arrayed, stored, archived, and accessed with security features enabling user access to be regulated.

6. The router of claim 5, wherein the router interconnects a front-end and a back-end;
wherein the front-end displays at least the data related to Securities and Exchange Commission compliance to the at least one interested party; and
wherein the back-end provides at least compliance modules and an approval module.

7. The router of claim 6, wherein the compliance modules comprise at least a repository of policies, forms, reports, and procedures for complying with Securities and Exchange Commission requirements.

8. The router of claim 6, wherein the approval module allows an individual to at least approve or reject the data stored in the record keeping and storage module.

9. The router of claim 8, wherein a data item that is approved is communicated by the router to at least one interested party in about close succession with the approval.

10. The router of claim 8, wherein if a data item is rejected the router notifies at least the user.

11. The router of claim 10, wherein the router communicates the data item to the user.

12. A method comprising the steps of, in combination:
creating an electronic repository of content, the content comprising at least one of Securities and Exchange Commission compliance data and a plurality of data related to a financial instrument or service;
providing an electronic routing tool for routing at least the Securities and Exchange Commission compliance data to an electronic location for approval for the purposes of indicating compliance with SEC requirements; and
wherein the router communicates at least one of approved Securities and Exchange Commission compliance data, approved data related to a financial instrument or service, and a combination thereof to interested parties in about close succession after approval.

13. The method of claim 12, wherein the plurality of data related to a financial instrument or service comprises at least one set of data related to the performance of a financial instrument or service.

14. A method of complying with Securities and Exchange Commission requirements, rules, and regulations comprising the steps of:
providing a plurality of electronic compliance related materials;
providing a router, wherein the router accepts submission of any of the plurality of electronic compliance related materials; and
providing an electronic compliance tool for the approval of compliance related materials;
wherein the router routes any of the plurality of compliance related materials to the compliance tool for approval; and
wherein the compliance tool allows compliance related materials to be at least approved and rejected.

15. The method of claim 14, wherein the router communicates each approved compliance related material to at least one interested party in about close succession of the approval of the compliance related material.

16. The method of claim 15, wherein the at least one interested party views at least the compliance related materials on a front-end.

17. The method of claim 14, wherein the router communicates each rejected compliance related material to at least one user in about close succession with the rejection of the compliance related material for the purpose of correction and resubmission of the compliance related material to the electronic compliance tool.

18. The method of claim 14, wherein the compliance tool comprises a location; wherein the router routes compliance related materials to the location from a user; and wherein an approval process for all compliance related materials in the location occurs.

19. The method of claim 14, wherein the user receives a communication upon the rejection of a compliance related material in the approval process.

20. A business method for demonstrating the benefits of a financial instrument such as a hedge fund, comprising the steps of:
providing access to series of modules that feature salient data points with respect to the involved financial instrument selected from the group consisting of commentary, news, weekly estimates, monthly actuals, personal portfolios, presentation/content format, user management information and compliance data;
interfacing with at least a primary and a secondary user set, whereby data arrayed by a primary user is made selectively available to predetermined or programmed third parties or secondary user set members;
creating a desired set of outputs using relational database elements and the data arrayed by the primary users, recording, tracking and storing said outputs;
updating predetermined aspects of the involved data points; and
repeating the above steps as needed to manage current and historical data sets and be able to present desired outputs with temporal proximity to the requests placed.
